(19) United States
(12) Patent Application Publication
(10) Pub. No.: US 2009/0056516 A1
(43) Pub. Date: Mar. 5, 2009

(54) Chain Gripping Device

(76) Inventor: Michael A. Gramiak, Prince Albert (CA)

Correspondence Address: ADE & COMPANY INC., 2157 Henderson Highway, WINNIPEG, MB, R2G1P9, CA

(21) Appl. No.: 12/196,312

(22) Filed: Aug. 22, 2008

(30) Foreign Application Priority Data
Aug. 27, 2007 (CA) 255489

(51) Int. Cl. B26D 7/02

(52) U.S. Cl. 83/462; 83/465; 269/9; 269/287

(57) ABSTRACT

A chain gripping device has a body which is arranged to be secured within the base clamps of a circular abrasive cutting saw. A clamping member supported on the body is arranged to clamp one of the links of the chain to be cut therein so that the link is in alignment with a cutting plane of the blade of the saw when the body is secured within the clamps of the saw. The clamping member includes jaws arranged to clamp only one side portion of the link to be clamped at a pair of positions spaced apart thereon to receive the blade therebetween to fully secure a link of a chain being cut throughout a cutting operation in a safe and secure manner.

This application claims foreign priority benefits from Canadian Patent Application 2,599,489, filed Aug. 27, 2007.

### FIELD OF THE INVENTION

The present invention relates to a chain gripping device for securing a chain to the base of a chain cutting saw comprising a blade movable relative to the base, and more particularly the present invention relates to a chain gripping device for securing one of the links of the chain to be parted in alignment with a cutting plane of the blade of a chain parting saw.

### BACKGROUND

Chains comprised of a plurality of links connected in series are commonly provided in large rolls from which desired lengths of chain can be cut. Parting or cutting chain is accomplished by many means including shear cutters or cutting torches.

A common tool for cutting chain comprises a circular abrasive cut-off saw as the circular abrasive blade is readily available and quickly cuts the chain, however use of such a tool is often dangerous as typical saws provide little means for adequately securing the chain relative to the moving blades. Accordingly it is common for the chain to be thrown from the moving blade during cutting which can injure an operator of the saw.

### SUMMARY OF THE INVENTION

According to one aspect of the invention there is provided a chain gripping device for use with an abrasive cutting saw for parting a chain comprising a plurality of links connected in series with one another, the saw comprising a base and a blade arranged for movement towards and away from the base, the chain gripping device comprising:

a body arranged for being secured to the base of the saw; and

a clamping member supported on the body and arranged to clamp one of the links of the chain therein for alignment with the blade of the saw.

By providing a body with a clamping member thereon specifically arranged for clamping a link of the chain therein, a particular link to be cut from a chain can readily be aligned with the cutting plane of the blade of the saw in a secure manner which prevents the chain from being thrown and potentially injuring the operator. By further providing a clamping member which is arranged to grip one side of the link, the chain can be more tightly gripped and secured in place relative to the blade. For optimally gripping the link in place, teeth may be provided on opposing jaws of the clamping member which are spaced apart for receiving the blade therebetween such that both ends of the chain being cut remain secured through the cutting action of the saw. By further providing different sizes of clamping members on a common body, many different sizes of chains can be readily accommodated with a single chain gripping device.

For a chain comprising links each having two elongate side portions joined at opposing ends by end portions and wherein the body is elongate in a longitudinal direction, the clamping member is preferably arranged to clamp one of the links of the chain therein such that the side portions of said one of the links are oriented in the longitudinal direction.

The body may comprise a pair of opposed flat sides extending in the longitudinal direction of the body so as to be arranged to be secured to the base of the saw with the longitudinal direction of the body being generally perpendicular to a cutting plane of the blade of the saw.

The clamping member may comprise a pair of opposed jaws movable relative to one another and arranged to receive a portion of said one of the links between the jaws.

The clamping member may be arranged to clamp only one of the side portions of said one of the links therein.

When the clamping member comprises a pair of opposed jaws movable relative to one another, each jaw preferably includes a recessed groove for mating engagement with a portion of said one of the links in which the groove is arranged to extend generally perpendicularly to a cutting plane of the blade.

The clamping member is preferably arranged to clamp said one of the links at two positions spaced along the link by at least a thickness of the blade for receiving the blade therebetween.

When the clamping member comprises a pair of opposed jaws, at least one of the jaws is preferably arranged to be pivotally coupled to the base at an inner end so as to be movable towards and away from the other jaw at an outer end, and the outer end of said at least one of the jaws preferably includes at least one tooth projecting from said at least one of the jaws towards the other jaw in which the tooth is arranged to be at least partially received through said one of links when said one of the links is clamped in the clamping member.

When the clamping member comprises a pair of opposed jaws, at least one of the jaws preferably includes two teeth projecting from said at least one of the jaws towards the other jaw in which the teeth are spaced apart by at least a thickness of the blade and the teeth are arranged to be at least partially received through said one of links when said one of the links is clamped in the clamping member.

The jaws may each include a pair of wings projecting laterally outward from opposing sides of the jaw in which the wings are spaced apart by at least a thickness of the blade. The teeth of said at least one of the jaws preferably project inwardly from a plane of the wings towards the other jaw.

The jaws may be biased away from one another to release said one of the links from the jaws.

There may be provided a retainer arranged to retain the clamping member in a clamped position in which said at least one of the links is clamped in the clamping member.

In one embodiment, the retainer comprises a threaded member.

Alternatively, the retainer may comprise a lever pivotally supported on the body for movement between a closed position engaged with the clamping member to retain the clamping member in a clamped position about said at least one of the links and an open position in which said one of the links is releasable from the clamping member. In this instance, the lever may be biased in the closed position to remain in the closed position.

The lever may also be biased in the open position to remain in the open position and the lever is rotated over-center between the open position and the closed position.

There may be provided a cam member rotatable with the lever and which engages the clamping member to retain the clamping member in the clamped position. In this instance, the cam member and the clamping member may include mating flat surfaces which are arranged to be engaged against one another in the closed position.

There may be provided a pair of clamping members of different size commonly supported on the body and arranged to clamp different sizes of chain therein.

When the body is elongate in a longitudinal direction between opposed ends, a pair of clamping members of different size are preferably supported at opposing ends of the body.

When the clamping member comprises a pair of opposed jaws pivotally coupled to one another on the body at an inner end of the jaws about a jaw axis so as to be movable towards and away from one another at an outer end of the jaws:

a lever is preferably pivotally supported on the body about a lever axis for movement between a closed position engaged with the clamping member to retain the clamping member in a clamped position about said at least one of the links and an open position in which said one of the links is releasable from the clamping member;

and the lever axis and the jaw axis are preferably oriented substantially parallel to one another.

In the instance when the body is elongate in a longitudinal direction and there are provided two clamping members of like configuration at opposing ends of the body different in size relative to one another, preferably:

the lever axis and the jaw axis of each clamping member extend in the longitudinal direction;

each clamping member further comprises a pivot pin pivotally coupling the jaws of the clamping member together at the respective jaw axis; and

the pivot pin of each clamping member supports the lever of the other clamping member thereon for rotation therewith about the respective lever axis of the lever such that the jaw axis of each clamping member is coaxial with the lever axis of the other clamping member.

Some embodiments of the invention will now be described in conjunction with the accompanying drawings in which:

### BRIEF DESCRIPTION OF THE DRAWINGS

FIG. 1 is perspective view of a first embodiment of the device shown mounted on a saw.

FIG. 2 is a top plan view of the first embodiment of the chain gripping device.

FIG. 3 and FIG. 4 are respective partly sectional and elevational views of one of the clamping members of the device of FIG. 2 shown in a released position and a clamped position respectively.

FIG. 5 is a perspective view of a fixed one of the jaws of the clamping members according to the first embodiment.

FIG. 6 is a top plan view of a second embodiment of the chain gripping device.

FIG. 7 and FIG. 8 are respective partly sectional and elevational views of the clamping member of the device according to FIG. 6 in a clamped position and a released position respectively.

FIG. 9 is a perspective view of one of the clamping members of the embodiment of FIG. 6 shown separated from the body and in a released position.

In the drawings like characters of reference indicate corresponding parts in the different figures.

### DETAILED DESCRIPTION

Referring to the accompanying figures there is illustrated a chain gripping device generally indicated by reference numeral 10. The device 10 is particularly suited for use in gripping a chain 12 comprised of a plurality of links 14 connected in series with one another to assist in gripping one of the links of the chain during a cutting or parting operation of the chain. The device 10 is suited for securing one of the links of the chain in place relative to an abrasive cutting saw 16.

A typical saw 16 includes a base 18 comprising a horizontal deck which is arranged to support an object to be cut thereon. A circular saw blade 20 comprising a thin flat disc of abrasive material is supported for rotation about a horizontal axis. The blade 20 is supported at the end of a pivot arm 22 which is pivoted at a rear of the deck forming the base 18 so that the blade is moveable about a horizontal axis of the pivot upwardly and downwardly generally towards and away from the base 18. The base 18 includes clamps 24 supported thereon in the form of upright clamping surfaces which are arranged to be adjustably spaced apart parallel to one another and generally perpendicular to the cutting plane of the blade to clamp an object therein to be cut in alignment across the cutting plane of the blade.

Although plural embodiments of the chain gripping device 10 are described in the following, the common features of the various embodiments will first be considered herein.

The device 10 generally includes a housing 30 comprising an elongate body extending in the longitudinal direction of the housing. As illustrated the housing comprises a tubing member of square cross section so as to be hollow along the length thereof, however the housing may also be assembled from suitable angle iron and the like. The housing 30 includes two vertical flat sides which are opposite one another and extend in the longitudinal direction to be parallel and spaced apart from one another for engagement by the clamping surfaces of the clamps 24 of the saw 16.

A clamping member 32 is supported at each end of the housing 30 with each clamping member 32 being arranged to clamp one of the links of the chain 12 therein. The clamping members 32 are different in size despite being substantially identical in configuration for accommodating different sizes of chain to be clamped therein.

Each clamping member 32 is arranged to clamp only one side portion of a chain in which the links each comprise two elongate side portions which are supported parallel and spaced apart from one another by end portions joined at opposing ends of the side portions. More particularly the clamping members 32 are each arranged to clamp one of the links so that the side portions extend in the longitudinal direction of the housing 30 to be oriented perpendicularly to the cutting plane of the blade of the saw when the housing 30 is supported within the clamps 24 of the saw base 18. Each clamping member 32 is also arranged to clamp a respective side portion of a link of the chain therein at two positions spaced along the respective side portion in which the two positions are spaced apart by at least the thickness of the blade of the saw so as to be arranged to receive the saw therebetween. A portion of each clamping member 32 is arranged to be received through the central opening of the link to securely engage the link and retain the link clamped within the clamping member 32.

Each clamping member 32 comprises two opposed jaws 34 which are pivotally coupled to one another at respective inner ends 36 in the housing 30. The jaws extend upwardly from the inner ends 36 to respective free outer ends 38 which are moveable towards and away from one another as the jaws are pivoted relative to one another about a jaw axis which is parallel to the longitudinal direction of the housing 30. The link of the chain is arranged to be clamped between the free outer ends 38 of the clamping member. Each jaw includes a slot 40 formed therein which extends radially inward from the free outer end 38 towards the inner end which has a thickness of at least the saw blade in which the slot 40 is arranged to be aligned with the cutting plane of the blade for receiving the blade in the slot 40. The slot 40 thus defines the two clamping positions of each clamping member which are arranged to clamp the side portion of a link therein at spaced positions therealong on opposing sides of the cutting plane.

Each jaw includes two teeth 42 formed at the free outer end thereof at the two clamping positions respectively. The teeth 42 are accordingly spaced apart from one another by at least the thickness of the saw blade in the slot 40 on each jaw. Each of the teeth 42 is formed to project inwardly from the jaw in a direction towards the opposing jaw so as to be arranged to be received through the opening in the link of the chain being clamped therein at least partway towards the teeth of the opposing jaw.

Each jaw 34 further comprises a pair of wings 44 which are also spaced apart on opposing sides of the jaw on the slot 40. Each wing 44 spans laterally outward from a rear side of the respective jaw opposite the teeth 42 on a front side so that the teeth are effectively arranged to span from the jaw away from the general plane locating the wings 44 therein. The wings extend outward away from the inner ends 36 of the respective jaw beyond the teeth 42 so as to be greater in height than the teeth by extending upwardly past the teeth. When one of the links of the chain is clamped within one of the clamping members, the wings of the two opposed jaws are arranged to be spaced apart from one another by at least a greatest width between the two side portions of one of the links of the chain.

Each clamping member includes a spring 46 which is coupled between the two jaws which acts in a direction to bias the jaws away from one another at the free outer ends so that the jaws are effectively biased into an open and released position where the chain is readily releasable from the clamping members.

A retainer 48 is provided which engages at least one of the jaws of the clamping member to effectively retain the clamping member in a clamped position in which one of the lengths of the chain is clamped between the jaws thereof.

The housing is provided with an opening 50 in a bottom side thereof directly below the inner ends of the jaws of each clamping member to permit filings from a cutting operation to be received therethrough instead of accumulating within the hollow interior of the housing.

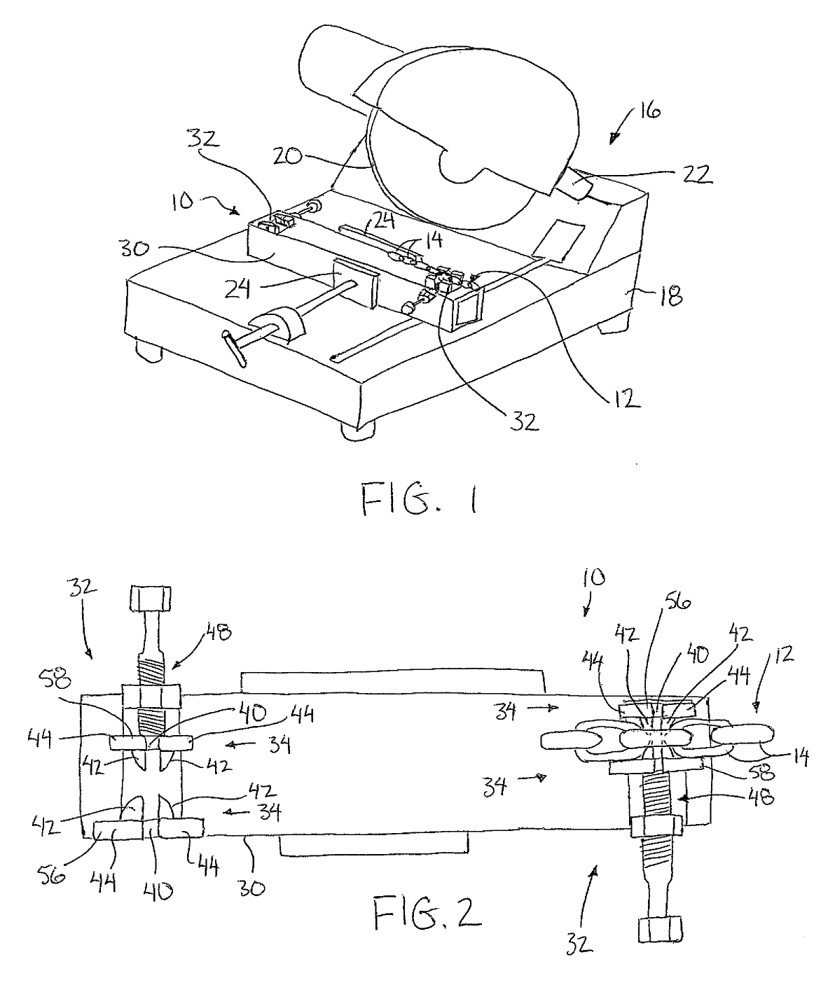

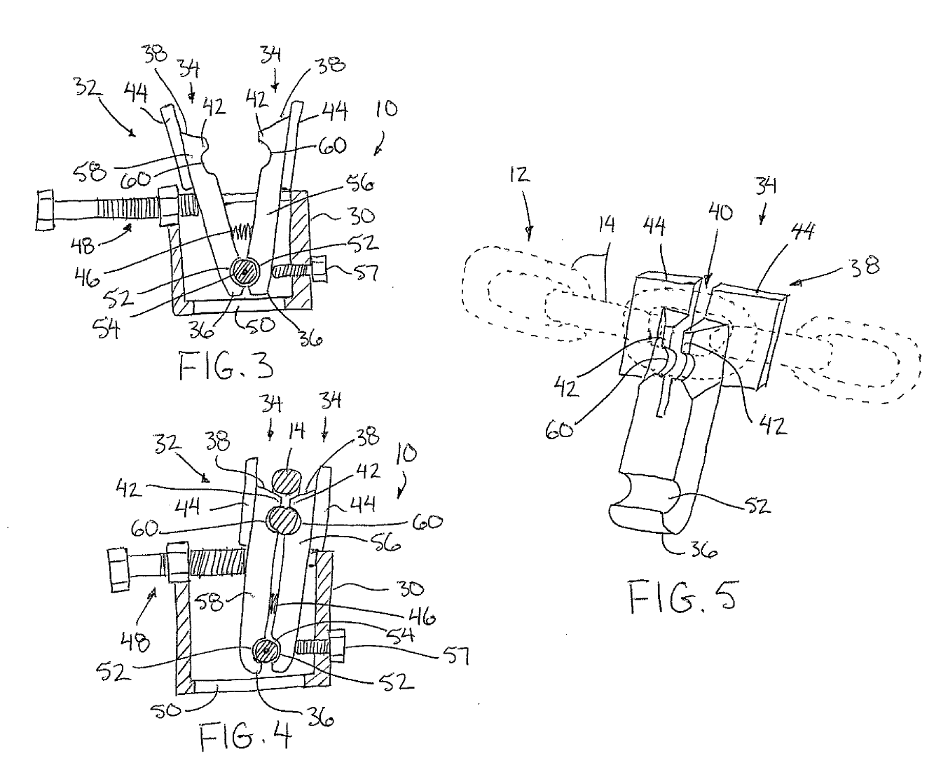

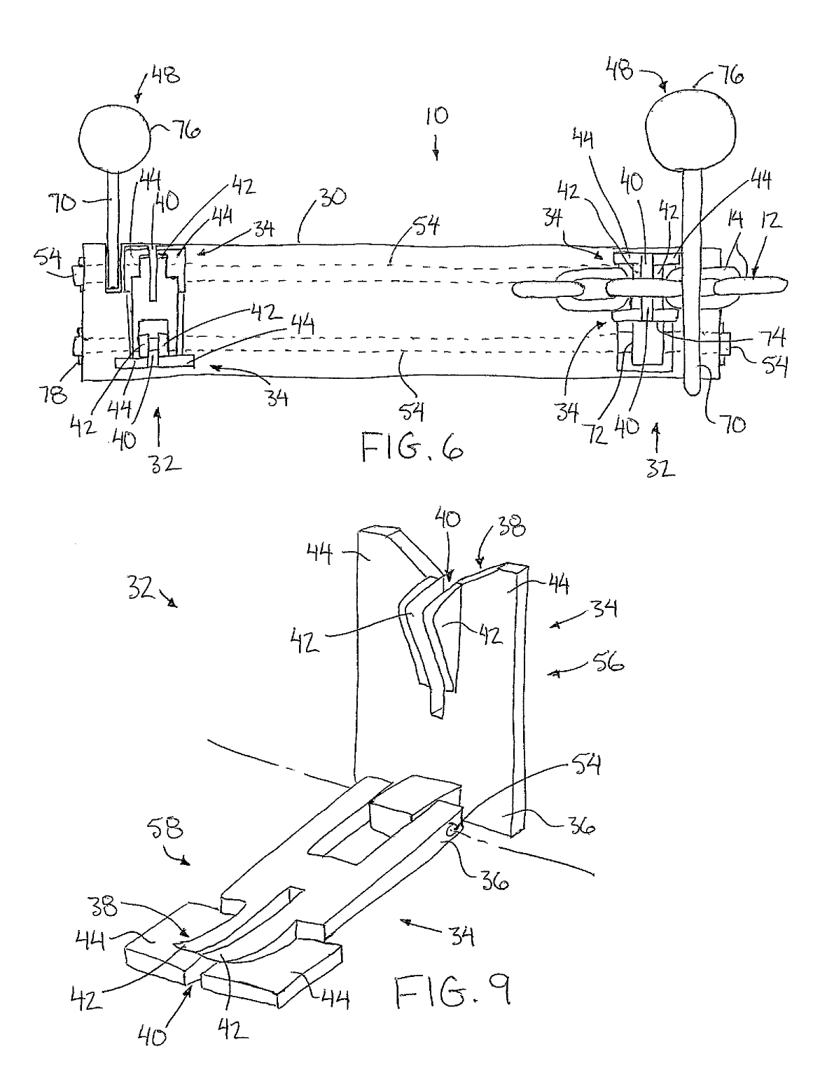

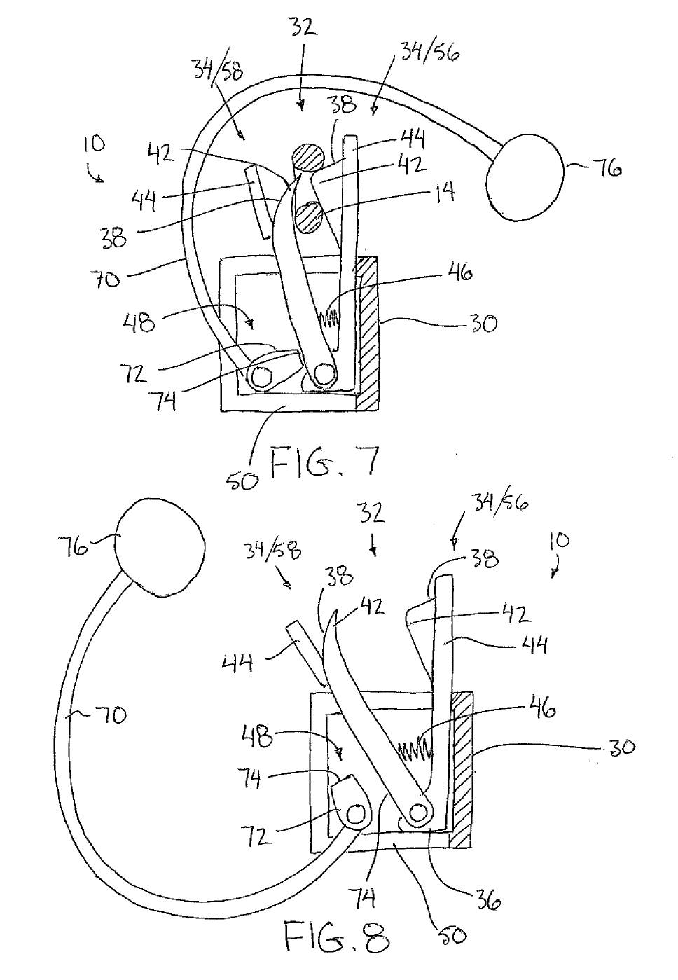

Turning now to FIGS. 1 through 5 the first embodiment will now be considered in further details.

In this embodiment, both of the jaws 34 include a lower semicircular groove 52 formed to extend laterally across a front side of the jaw which confronts and faces the opposing jaw. The groove 52 is thus oriented to extend in the longitudinal direction of the housing parallel to the jaw axis where a pivot pin 54 is located. The pivot pin is matingly received within the lower semicircular groove 52 of each jaw to define the jaw axis about which both of the jaws pivot. A fixed one of the jaws 56 is held against one side of the pivot pin 54 by a suitable set screw inserted through the side of the housing to clamp the inner end of the fixed jaw 56 between the set screw and the pivot pin. The other moveable one of the jaws 58 is only held by the retainer 48 when the retainer is closed so that when the retainer is open, the moveable jaw 58 remains freely pivotal about the pivot pin 54 so as to be biased away from the fixed jaw into an open and released position of the clamping member by the spring 46.

The retainer 48 in this embodiment comprises a threaded screw which is threadably received through an opening in the housing so that the screw defining the retainer 48 is rotatable about a respective longitudinal axis which extends horizontally and perpendicularly to the longitudinal direction of the hosing and the jaw axis. Rotating the threaded screw of the retainer within the threaded opening in the housing acts to displace the screw towards and away from the fixed jaw 56 which permits a closing pressure to be applied by the retainer 48 to the moveable jaw 58 to close the moveable jaw towards the fixed jaw and thereby clamp one of the links of the chain therein. A reservoir for containing a dry lubricant communicates with the threaded opening in the housing which receives the threaded screw therein so that the retainer 48 remains readily lubricated for rotation relative to the housing within which it is received.

In this embodiment, each jaw also includes an upper semicircular groove 60 spanning across the front face of each jaw which faces the opposing jaw in which the groove 60 is oriented generally horizontally so as to be parallel to the jaw axis. The upper groove 60 is located near the free outer end of each jaw but spaced slightly inwardly therefrom so as to define the teeth of the jaw as the portion of the front face of the jaw which is located above the groove 60 and projects inwardly towards the opposing jaw in relation to the groove 60.

Turning now to FIGS. 6 through 9, a second embodiment of the chain gripping device will now be described in further detail.

In this embodiment, the jaws 34 again comprise a fixed jaw 56 arranged to be held in fixed relation to the housing, and a moveable jaw 58 which is moveable at the outer free end thereof towards and away from the outer end of the fixed jaw 56.

In this embodiment both the fixed jaw 56 and the moveable jaw 58 include cooperating apertures therein through which the pivot pin 54 is received to define the jaw axis of relative pivotal movement between the jaws.

The fixed jaw 56 of each clamping member is arranged so that the wings 44 extend substantially the full height of the jaw from the inner end to the outer end thereof in a common plane which is oriented to be generally vertical and parallel to an outer sidewall of the housing when the jaw is installed on the housing. The teeth 42 comprise two spaced apart and generally parallel planar members which project forwardly from the plane of the wings towards the opposing jaws. The triangular shape of the teeth 42 are arranged to extend from a base at the wings to an apex pointing towards the opposing jaw so that a bottom side of each tooth 42 of the fixed jaw 56 is sloped generally downwardly and inwardly towards the wings. The bottom sloping surface of each jaw slopes downwardly to meet a top side of the housing at an acute interior angle facing the opposing jaw for guiding the side portion of the link to be clamped therein under clamping force from the opposing moveable jaw 58.

In this embodiment the moveable jaw has an outer free end which is curved upwardly and forwardly towards the opposing jaw with a slot being formed therein to define the two spaced apart teeth 42 at the free outer end. The wings 44 are supported rearwardly of the teeth, opposite the fixed jaw, so that the teeth project from the plane of the wings towards the opposing jaw. As in the previous embodiment the wings are arranged to be both wider and taller than the remaining body of the moveable jaw 58.

The retainer 48 in the second embodiment includes a lever 70 which is pivoted at an inner end about a lever axis oriented parallel to the jaw axis and the longitudinal direction of the housing. More particularly, the lever 70 is mounted on the pivot pin 54 of the other clamping member relative to the clamping member with which the lever is operatively associated. The lever 70 and the pivot pin 54 are together pivotal about the lever axis which is effectively defined by and coaxial with the jaw axis of the other clamping member.

The retainer 48 further comprises a cam lobe 72 which is also mounted on the pivot pin 54 of the opposing clamping member for rotation with the pivot pin and the respective lever 70 between a respective open and released position and a respective closed and clamped position. The cam lobe 72 is arranged for engaging the moveable jaw so that when the lever is pivoted to a closed or clamped position the cam lobe 72 engages a rear face of the moveable jaw, opposite the fixed jaw, to retain the moveable jaw in a closed and clamped position in which one of the links of the link is clamped between the opposed jaws of the clamping members.

The cam lobe 72 and the moveable jaw have mating flat surfaces 74 which are arranged to be engaged with one another in the closed and clamped position. Thus in the closed and clamped position, the mating flat surfaces of the cam lobe and the moveable jaw act to resist pivotal movement of the lever back to an open position to further retain the clamping member in the clamped position. When the lever 70 is pivoted to an open position, the cam lobe 72 is moveable away from the fixed jaw so as to permit the moveable jaw also to be moveable away from the fixed jaw so that the clamped link of the chain is releasable from the clamping member.

The lever 70 extends generally upward to a free end thereof which supports a weighted handle 76 thereon. The weighted handle 76 at the free end of the lever 70 is arranged to be rotated over centre between the open and closed positions of the lever so that in both open and closed positions gravity acts on the handle to bias and retain the lever in that respective open or closed position that the lever is currently in.

When assembling the device according to the second embodiment each pivot pin 54 is inserted through the cooperating apertures in the jaws of the respective clamping member and the cam lobe and the lever of the opposing clamping member are secured at the opposing end thereof for rotation therewith. The ends of each pivot pin are arranged to project through cooperating apertures in end plates on the opposing ends on the housing 30 and are further arranged to received retainer clips mounted thereon to fix the longitudinal position of the pivot pins within the housing and maintain the clamping members in the assembled configuration while permitting the pivot pins to remain rotatable about respective longitudinal axes thereof.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A chain gripping device for use with an abrasive cutting saw for parting a chain comprising a plurality of links connected in series with one another, the saw comprising a base and a blade arranged for movement towards and away from the base, the chain gripping device comprising:
a body arranged for being secured to the base of the saw; and
a clamping member supported on the body and arranged to clamp one of the links of the chain therein for alignment with the blade of the saw.

2. The device according to claim 1 for a chain comprising links each having two elongate side portions joined at opposing ends by end portions wherein the body is elongate in a longitudinal direction and the clamping member is arranged to clamp one of the links of the chain therein such that the side portions of said one of the links are oriented in the longitudinal direction.

3. The device according to claim 2 wherein the body comprises a pair of opposed flat sides extending in the longitudinal direction of the body so as to be arranged to be secured to the base of the saw with the longitudinal direction of the body being generally perpendicular to a cutting plane of the blade of the saw.

4. The device according to claim 1 wherein the clamping member comprising a pair of opposed jaws movable relative to one another and arranged to receive a portion of said one of the links between the jaws.

5. The device according to claim 1 for a chain comprising links each having two elongate side portions joined at opposing ends by end portions wherein the clamping member is arranged to clamp only one of the side portions of said one of the links therein.

6. The device according to claim 1 wherein the clamping member comprises a pair of opposed jaws movable relative to one another and each jaw includes a recessed groove for mating engagement with a portion of said one of the links in which the groove is arranged to extend generally perpendicularly to a cutting plane of the blade.

7. The device according to claim 1 wherein the clamping member is arranged to clamp said one of the links at two positions spaced along the link by at least a thickness of the blade for receiving the blade therebetween.

8. The device according to claim 1 wherein the clamping member comprises a pair of opposed jaws in which at least one of the jaws is arranged to be pivotally coupled to the base at an inner end so as to be movable towards and away from the other jaw at an outer end, the outer end of said at least one of the jaws including at least one tooth projecting from said at least one of the jaws towards the other jaw in which the tooth is arranged to be at least partially received through said one of links when said one of the links is clamped in the clamping member.

9. The device according to claim 1 wherein the clamping member comprises a pair of opposed jaws in which at least one of the jaws includes two teeth projecting from said at least one of the jaws towards the other jaw in which the teeth are spaced apart by at least a thickness of the blade and the teeth are arranged to be at least partially received through said one of links when said one of the links is clamped in the clamping member.

10. The device according to claim 9 wherein said at least one of the jaws includes a pair of wings projecting laterally outward from opposing sides of the jaw, the wings being spaced apart by at least a thickness of the blade, the teeth of said at least one of the jaws projecting inwardly from a plane of the wings towards the other jaw.

11. The device according to claim 1 wherein the clamping member comprises a pair of opposed jaws arranged to clamp said one of the links therebetween, the jaws being biased away from one another to release said one of the links from the jaws.

12. The device according to claim 1 wherein there is provided a retainer arranged to retain the clamping member in a clamped position in which said at least one of the links is clamped in the clamping member.

13. The device according to claim 12 wherein the retainer comprises a threaded member.

14. The device according to claim 12 wherein the retainer comprises a lever pivotally supported on the body for movement between a closed position engaged with the clamping member to retain the clamping member in a clamped position about said at least one of the links and an open position in which said one of the links is releasable from the clamping member, the lever being biased in the closed position to remain in the closed position.

15. The device according to claim 14 wherein the lever is biased in the open position to remain in the open position and the lever is rotated over-center between the open position and the closed position.

16. The device according to claim 14 wherein there is provided a cam member rotatable with the lever and which engages the clamping member to retain the clamping member in the clamped position, the cam member and the clamping member including mating flat surfaces which are arranged to be engaged against one another in the closed position.

17. The device according to claim 1 wherein there is provided a pair of clamping members of different size commonly supported on the body and arranged to clamp different sizes of chain therein.

18. The device according to claim 1 wherein the body is elongate in a longitudinal direction and there is provided a pair of clamping members of different size supported at opposing ends of the body.

19. The device according to claim 1 wherein:
the clamping member comprises a pair of opposed jaws pivotally coupled to one another on the body at an inner end of the jaws about a jaw axis so as to be movable towards and away from one another at an outer end of the jaws;
a lever pivotally supported on the body about a lever axis for movement between a closed position engaged with the clamping member to retain the clamping member in a clamped position about said at least one of the links and an open position in which said one of the links is releasable from the clamping member;
the lever axis and the jaw axis being oriented substantially parallel to one another.

20. The device according to claim 19 wherein:
the body is elongate in a longitudinal direction;
there are provided two clamping members of like configuration at opposing ends of the body;
the two clamping members are different in size relative to one another;
the lever axis and the jaw axis of each clamping member extend in the longitudinal direction;
each clamping member further comprises a pivot pin pivotally coupling the jaws of the clamping member together at the respective jaw axis; and
the pivot pin of each clamping member supports the lever of the other clamping member thereon for rotation therewith about the respective lever axis of the lever such that the jaw axis of each clamping member is coaxial with the lever axis of the other clamping member.
